(19) United States
(12) Patent Application Publication
(10) Pub. No.: US 2025/0015507 A1
(43) Pub. Date: Jan. 9, 2025

(54) SYSTEMS AND METHODS USING PASSIVE REFLECTORS TO ENHANCE NON-LINE-OF-SIGHT (NLOS) SIGNALS

(71) Applicant: 3M INNOVATIVE PROPERTIES COMPANY, St. Paul, MN (US)

(72) Inventors: Ivan Lemesh, Minneapolis, MN (US); Michael S. Graff, Woodbury, MN (US); Sergei A. Manuilov, Bayport, MN (US); John J. Sullivan, Hudson, WI (US)

(21) Appl. No.: 18/705,049

(22) PCT Filed: Oct. 26, 2022
(86) PCT No.: PCT/IB2022/060306

§ 371 Date: Apr. 26, 2024

Related U.S. Application Data
(60) Provisional application No. 63/263,775, filed on Nov. 9, 2021.

(51) Int. Cl. H01Q 15/14; H01Q 1/32; H01Q 3/46

(52) U.S. Cl. CPC H01Q 15/14; H01Q 1/3225; H01Q 3/46

(57) ABSTRACT

Systems and methods using passive reflectors or reflectarrays are provided to enhance non-line-of-sight (NLOS) wireless signals. Multiple reflectarrays are combined and positioned to cover a wide range of user positions/beam angles. The passive reflectarrays include at least one of a first reflectarray configured to split an incident beam and a second reflectarray configured to steer the incident beam with an off-plane of incidence.

### BACKGROUND

The fifth generation technology standard (5G) for broadband cellular networks uses high frequency radio waves in the 6 GHz to 300 GHz spectrum region, referred heretofore as microwaves or millimeter waves, or mmWaves. The higher-frequency radio waves have a shorter useful physical range, requiring smaller geographic cells. Line-of-Sight (LOS) links using highly directional antennas with high gain provide a focused beam directly to the mobile user. The LOS connection is used to compensate for the higher path loss and signal degradations at mmWave frequencies. Beam steering of radiofrequency (RF) waves for LOS connection is becoming an indispensable part of modern wireless communications now that the frequency of mobile network providers is getting well into the mmWave regime. At higher frequencies, the propagation losses typically increase, while path components generated by reflections (e.g., from building walls, window glass, metal surfaces) become inefficient (e.g., due to losses, diffuse scattering, or multipath interference), which results in various dead zones. This issue is typically resolved by introducing a much denser network of base stations and repeaters. However, the cost of such enterprise, involving the multitude of active phase array antennas (which become even more complex for mm-wave spectrum as they require active beamforming and Multiple-Input-Multiple-Output (MIMO) functionalities), repeaters, and associated installation and licensing, is enormous.

### SUMMARY

There is a desire to provide cost-effective solutions for beam steering of radiofrequency (RF) waves in wireless communications. In one aspect, the present disclosure provides a method of enhancing non-line-of-sight (NLOS) signal for wireless communications. The method includes providing a plurality of passive reflectarrays including a first reflectarray and a second reflectarray, at least one of the reflectarrays comprising a pattern of repeating unit cells of resonating elements configured to reflect an incident radiofrequency (RF) electromagnetic wave at a wavelength λ in a range from about 1.0 mm to about 10.0 cm, the first reflectarray having a first phase gradient along a first longitudinal direction thereof, the second reflectarray having a second phase gradient along a second longitudinal direction thereof; and positioning at least one of the first and second passive reflectarrays to face to the incident RF electromagnetic wave such that the incident RF electromagnetic wave is reflected by the first and second passive reflectarrays with a signal improvement of at least 3 dB, with the signal improvement being defined as an increase in the signal strength in at least one NLOS direction relative to a baseline signal strength measured without the benefit of the plurality of passive reflect arrays.

In another aspect, the present disclosure provides a system of enhancing non-line-of-sight (NLOS) signal for wireless communications. The system includes one or more passive reflectarrays, at least one of the reflectarrays including a pattern of repeating unit cells of resonating elements configured to reflect an incident radiofrequency (RF) electromagnetic wave at a wavelength λ in a range from about 1.0 mm to about 10.0 cm. The one or more passive reflectarrays include at least one of a first reflectarray configured to split an incident beam and a second reflectarray configured to steer the incident beam with an off-plane of incidence.

### BRIEF DESCRIPTION OF THE DRAWINGS

FIG. 1 is a schematic plan view of geometry patterns of reflectarrays, according to some embodiment.

FIG. 1A is a schematic diagram of reflection behavior of a reflectarray.

FIG. 2A is a schematic cross-sectional view and a top plan view of an exemplary reflectarray.

FIG. 2B is plots of reflection curves for the reflectarray of FIG. 2A with different phase gradients ∇ϕ.

FIG. 2C is a schematic diagram of reflection behavior for specular mirror reflectors.

FIG. 2D is a schematic diagram of reflection behavior for constant phase gradient structures.

FIG. 3A is a schematic diagram of an indoor application with a basis set of reflectarrays at an L-junction, according to one embodiment.

FIG. 3B is a schematic diagram of an indoor application with a basis set of reflectarrays at an L-junction, according to one embodiment.

FIG. 3C is a schematic diagram of an indoor application with a basis set of reflectarrays at an L-junction, according to one embodiment.

FIG. 3D is a schematic diagram of an indoor application with a basis set of reflectarrays at an L-junction, according to one embodiment.

FIG. 3E is a schematic diagram of an indoor application with a basis set of reflectarrays at an L-junction, according to one embodiment.

FIG. 4A is a schematic diagram of an indoor application with a basis set of reflectarrays at a T-junction, according to one embodiment.

FIG. 4B is a schematic diagram of an indoor application with a basis set of reflectarrays at a T-junction, according to one embodiment.

FIG. 4C is a schematic diagram of an indoor application with a basis set of reflectarrays at a T-junction, according to one embodiment.

FIG. 4D is a schematic diagram of an indoor application with a basis set of reflectarrays at a T-junction, according to one embodiment.

FIG. 5A is a schematic diagram of an indoor application with a basis set of reflectarrays at a four-way-junction, according to one embodiment.

FIG. 5B is a schematic diagram of an indoor application with a basis set of reflectarrays at a four-way-junction, according to one embodiment.

FIG. 6A is a schematic diagram of a beam-splitting reflection behavior.

FIG. 6B is a schematic diagram of a reflection behavior for an off-plane of incidence steering.

FIG. 6C is a schematic diagram of an indoor application with a combination of reflectarrays on a ceiling and a floor, according to one embodiment.

FIG. 7A is a schematic diagram of an indoor application with a combination of reflectarrays at an L-junction, according to one embodiment.

FIG. 7B is a schematic diagram of an indoor application with a combination of reflectarrays at a T-junction, according to one embodiment.

FIG. 7C is a schematic diagram of an indoor application with a combination of reflectarrays at an L-junction, according to one embodiment.

FIG. 7D is a schematic diagram of an indoor application with a combination of reflectarrays at a T-junction, according to one embodiment.

FIG. 7E is a schematic diagram of an indoor application with a combination of reflectarrays at an L-junction, according to one embodiment.

FIG. 7F is a schematic diagram of an indoor application with a combination of reflectarrays at an L-junction, according to one embodiment.

FIG. 7G is a schematic diagram of an indoor application with a combination of reflectarrays at an L-junction, according to one embodiment.

FIG. 7H is a schematic diagram of an indoor application with a combination of reflectarrays at a T-junction, according to one embodiment.

FIG. 7I is a schematic diagram of an indoor application with a combination of reflectarrays at a T-junction, according to one embodiment.

FIG. 7J is a schematic diagram of an indoor application with a combination of reflectarrays at a four-way junction, according to one embodiment.

FIG. 8A is a schematic diagram of a characterization setup.

FIG. 8B is a top plan view of Examples 0, 1 and 2.

FIG. 8C is plots of reflection versus frequency curves for Examples 0, 1 and 2.

FIG. 8D is plots of scattering curves at frequencies corresponding to the best performance of selected 0°→θ₁ geometries for Examples 0, 1 and 2.

FIG. 8E is plots of reflected angle θᵣ versus incident angle θᵢ for frequencies chosen at FIG. 8C.

FIG. 8F is plots of signal strength versus incident angle for Examples 0, 1 and 2.

FIG. 8G is a schematic cross-sectional view of the reflectarray film of Example 1.

FIG. 8H is a schematic cross-sectional view of the reflectarray film of Example 2.

FIG. 9A is a top plan view of Example 3.

FIG. 9B is a top plan view of Example 4.

FIG. 9C is a top plan view of Example 5.

FIG. 9D is a schematic diagram of a characterization setup for Example 4.

FIG. 9E is a schematic diagram of a characterization setup for Example 5.

FIG. 9F is plots of reflection spectra for Example 0, 3, 4, and 5.

FIG. 9G is plots of scattering curves for Example 0, 3 and 4.

FIG. 9H is a schematic cross-sectional view of the reflectarray film of Examples 3-5.

FIG. 10A is a schematic diagram of a testing environment at a L-junction for Example 6.

FIG. 10B is plots of output angle versus incident angle for reflectarray combinations Array 1 and Array 2 of Example 6.

FIG. 10C is plots of output angle versus frequency for Example 6.

FIG. 10D is plots of measured total reflection versus frequency for Example 6.

FIG. 10E is a schematic diagram of a testing setup for Example 6 at an L-junction.

FIG. 10F is plots of total reflection versus total path-length of reflectarrays at 31.1 GHz.

In the following description of the illustrated embodiments, reference is made to the accompanying drawings, in which is shown by way of illustration, various embodiments in which the disclosure may be practiced. It is to be understood that the embodiments may be utilized and structural changes may be made without departing from the scope of the present disclosure. The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

The present disclosure provides non-line-of-sight (NLOS) signal enhancements such as at T-, L-, and four-way junctions. In some embodiments, passive reflectors or reflectarrays and combinations thereof such as, e.g., metalized, or conductive films, passive repeater antennas, reflectarrays, etc., are provided to connect one part of the communications network to another, where each part of the network could be a final user, repeater, base station, or another active component that redistributes communication signals and where each or single component of this network is capable of active beam steering. Here, the Non-Line-of-Sight (“NLOS”) refers to zones where users of devices may have either no wireless access, significantly reduced coverage, or impaired coverage of some sort. The embodiments described herein provide generic solutions which can be adapted in various scenarios indoors such as, e.g., in skyways, at corridors, hallways of office spaces or basement floors, warehouses, distribution centers, factory floors; outdoors such as at street junctions, building blockages, urban canyons, etc.

As used herein, the term “reflectarray” refers to a planar array of phase shifting elements backed up by a ground plane that, when illuminated by a feeding antenna (which can be nearby or far way, stationary or moving), reflects its RF radiation in a certain direction (or redistributes to multiple directions).

As used herein, the term “resonating elements” or “phase shifting elements” refers to the elementary building blocks of reflectarray that resonate in the presence of radio frequency (RF) radiation, with their phase characteristics dependent on their dimensions (geometry). A resonating element can be made of a metallic material or a high-dielectric-constant or high-k dielectric material, or it can be an open space within a conductive plane or mesh

As used herein, the term “beam steering” refers to the static property of reflectarrays to redirect an incident RF radiation by a certain desired amount (i.e., without dynamic tunability).

In various embodiments, one or more reflectarray articles are provided for beam steering of radiofrequency (RF) waves. The reflectarray articles each may include a frequency selective surface (FSS) layer including a pattern of resonating elements configured to reflect an incident radiofrequency (RF) electromagnetic wave at a free-space wavelength λ in a range from about 1.0 mm to about 10.0 cm. In some embodiments, each resonating element may include a wire-like, a patch-like structure, or an empty void space in a conductive mesh. A reflectarray article may further include a ground plane layer including a patterned conductor formed by metallic traces defining cells of a continuous metallic mesh disposed on a major surface thereof. One or more dielectric layers can be provided to be sandwiched between the resonating elements and the ground plane layer, or on the opposite sides of the patterned or ground plane layers.

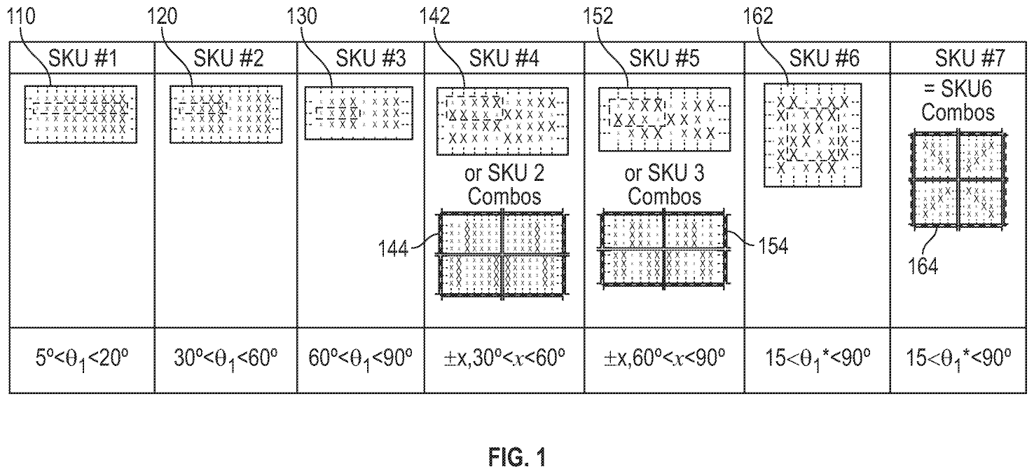

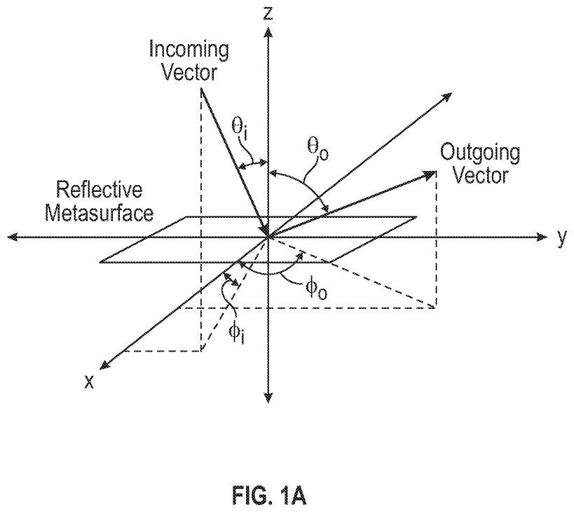

FIG. 1 is a schematic plan view of geometry patterns of various reflectarrays, according to some embodiment. The reflectarrays each include a pattern of resonating elements which can be a metastructure including a two dimensional array of repeating unit cells as shown in the respective rectangular boxes in dashed lines. The geometry pattern of a metastructure can be designed to provide various reflectarray angles. Here, the reflectarray angle, θ_{array}, (also denoted as θ_{array,n} or θₙ for multiple reflectarrays n) refers to the intrinsic (frequency-dependent) property of a reflectarray that describes its response to a normally incident RF wave, i.e., a corresponding angle of reflection with respect to the surface normal. FIG. 1A depicts a representation of a metastructure or metasurface configured to selectively reflect a particular incoming vector (with an incident angle θᵢ with respect to the surface normal along the z axis, and a projecting angle φᵢ with respect to the x axis) to a particular outgoing vector (with a reflecting angle θᵣ with respect to the surface normal along the z axis, and a projecting angle φᵣ with respect to the x axis). The incoming and outgoing vectors have a generalized geometric relationship to each other. When the incident angle θᵢ=0, the reflecting angle θᵣ corresponds to the reflectarray angle, θ_{array}.

As a benchmark, a metallic mirror film delivers a specular steering performance, where the reflectarray angle θ_{array} is about 0°. Negative reflectarray angles (θ_{array}<0) refer to the case in which a reflectarray with a positive reflectarray angle of |θ_{array}| is rotated by 180 degrees in its film plane (e.g., the XY-plane in FIG. 1A). In the embodiments of FIG. 1, the passive reflectarray 110 has a reflectarray angle θ_{array} from about 5° to about 20°; the passive reflectarray 120 has a reflectarray angle θ_{array} from about 300 to about 60°; the passive reflectarray 130 has a reflectarray angle θ_{array} from about 600 to about 90°; the passive reflectarrays 142, 144 each have a reflectarray angle θ_{array} from about 300 to about 600 or from about −30° to about −60°; the passive reflectarrays 152, 154 each have a reflectarray angle θ_{array} from about 600 to about 900 or from about −60° to about −90°; the passive reflectarrays 162, 164 each have a reflectarray angle θ_{array} from about 150 to about 90°.

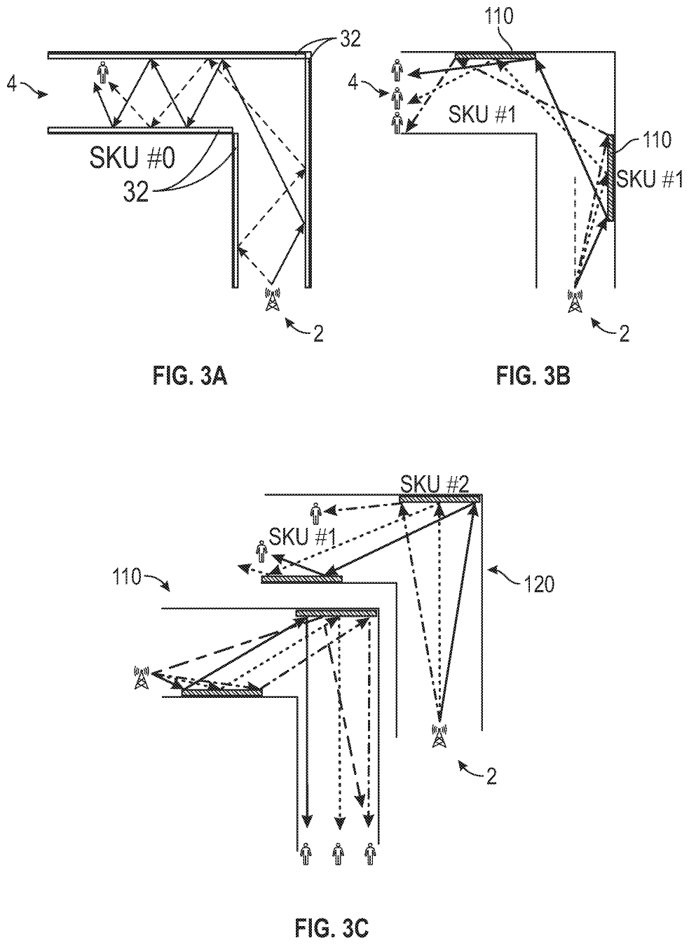

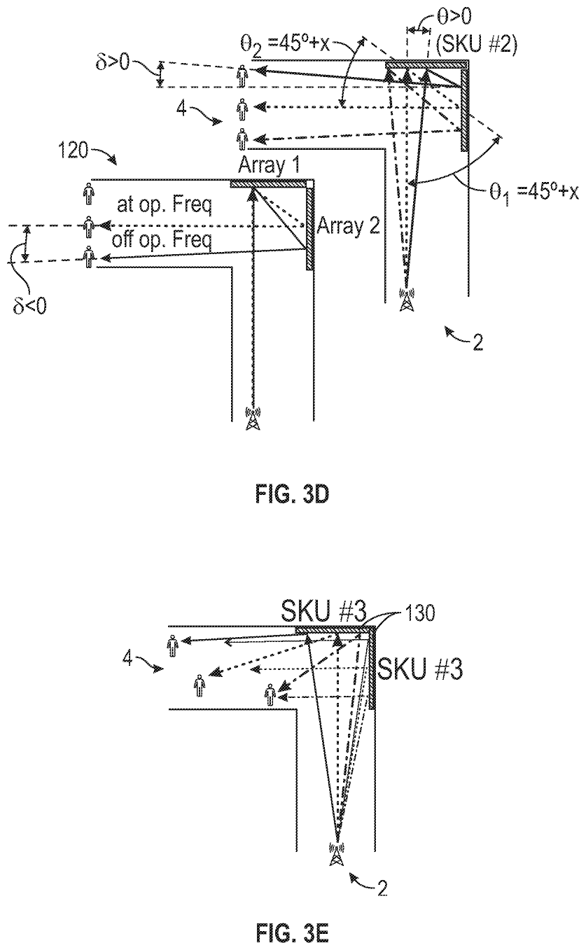

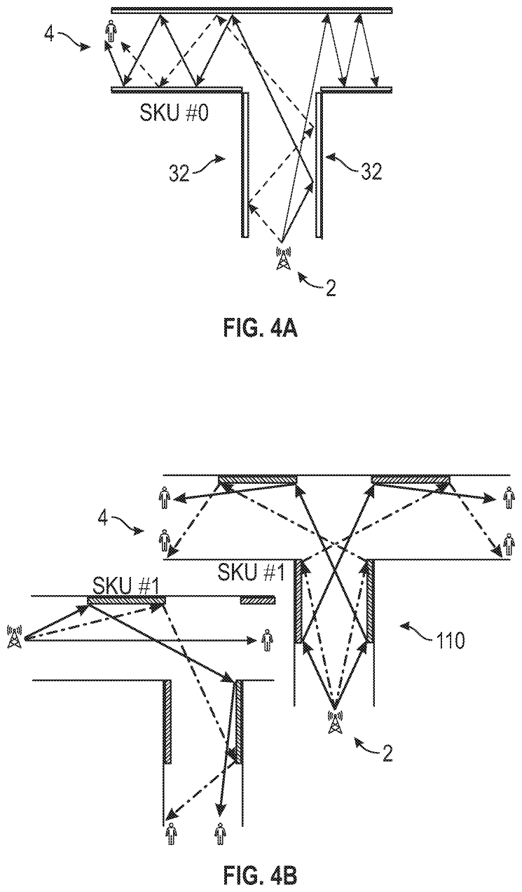

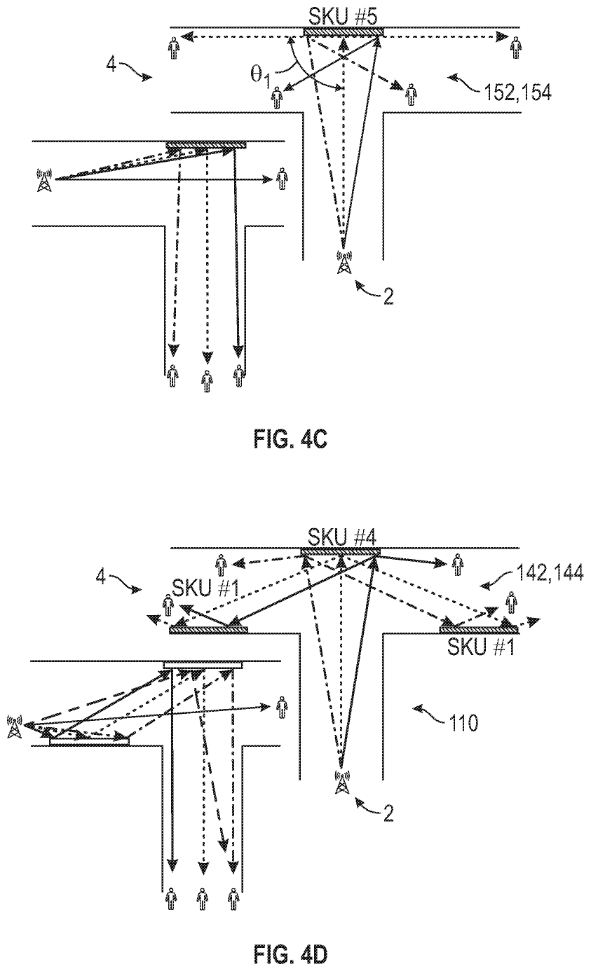

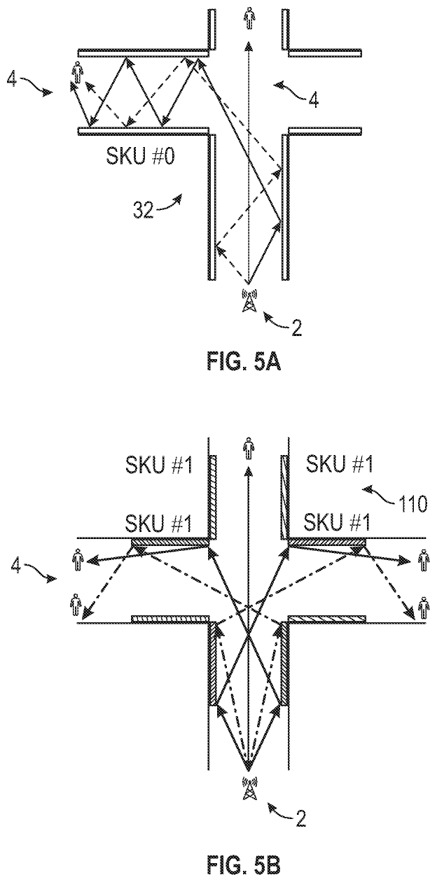

Structures 110, 120, 130 (SKUs 1-3) represent generic reflectarrays that substantially satisfy the constant phase gradient condition. Structure 110 (SKU1) has a small reflectarray angle (5°<θ_{array}<20°), and can be used for cases where a slight redirection of beam is preferred (compared with a specular response), e.g., in beam paths involving more than one reflectarray panels (e.g., doublets or a pair of reflectarrays), placed in L-junctions (see, e.g., FIG. 3B), T-junctions (see, e.g., FIG. 4B), and four-way junctions (see, e.g., FIG. 5B) as well as auxiliary structures for L-junctions (see, e.g., coupled with 120 structure as in FIG. 3C) and T-junctions (see, e.g., coupled with 142/144 structure as in FIG. 4D). Structure 120 (SKU 2) has an intermediate value of reflectarray angle (30°<θ_{array}<60°) and can be used either to complement the aforementioned auxiliary structure (see, e.g., FIG. 3C) or as a standalone doublet (see, e.g., FIG. 3D). In the latter case, the optimum performance is delivered when either both arrays have θ_{array}=45°, or when their reflectarray angles sum up to around 90°, i.e., 80°<|θ_{array,1}|+|θ_{array,2}|<100°. Structure 130 (SKU3) has a large reflectarray angle (60°<θ_{array}<90°), and represents the most commonly applied scenario, typically applied as standalone. In one embodiment, structure 130 can be applied as a doublet, which results in two distinct signal pathway components as depicted in FIG. 3E.

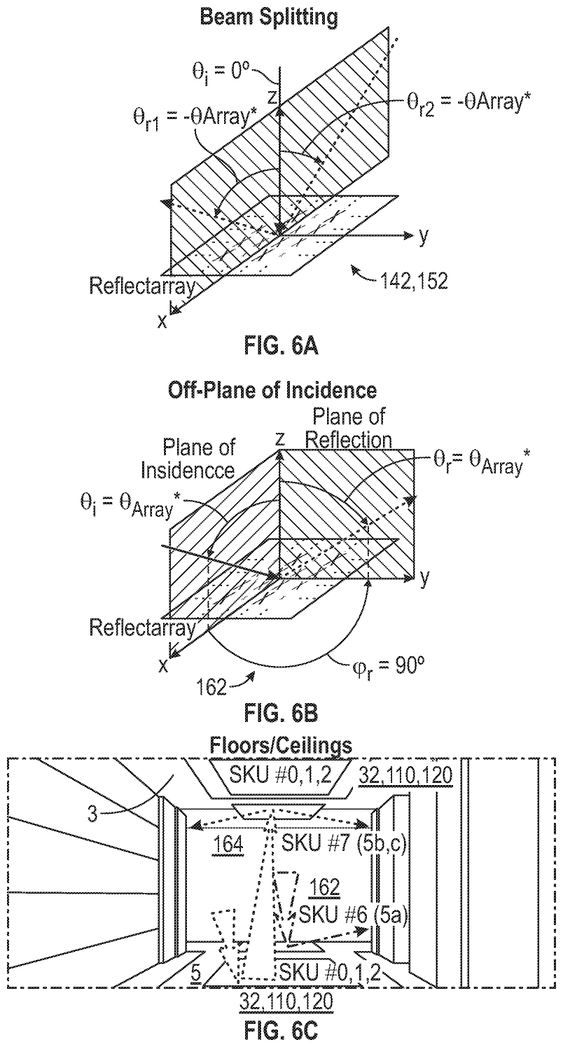

Structures 142, 144 exhibit beam-splitting behavior for intermediate values of reflectarray angles, 30°<|θ_{array}|<60°, and can be used as auxiliary structures for T-junctions (see, e.g., FIG. 4D). One way to implement this behavior is to make a twice larger unit cell, with upper and lower rows stacked in the opposite order (142), which is visualized in FIG. 6A. Alternatively, one can make a stack of oppositely oriented patches (144). Structures 152, 154 are equivalent to 142, 144 but use larger reflectarray angles, 30°<|θ_{array}|<60°, which can be used for single structures in T-junctions (see, e.g., FIG. 4C).

Structure 162 can make use of floors and ceilings of L-junctions (see, e.g., FIG. 6C) by performing an off-plane of incidence beam redirection. Its unit cell has a square n×n shape, where n is the number of constituent elements. Every row has the same gradient direction (which for the regular constant phase gradient structure would translate to 15°<θ_{array}<90° performance). The corresponding structure along with its beam redirection performance (θᵢ=θ_{array}, φᵢ=0° θᵣ=θ_{array}*, φᵣ=90°) is depicted in FIG. 6B. Structure 164 represents a stack of oppositely oriented patches (162) and can be applied on floors and ceiling of T-junctions (FIG. 6C). Structures 162 and 164 each can be used in combinations with specular reflectors (32) and small- (110) and intermediate-(120) angle reflectarrays in order to guide the signal across the hallway floor and ceiling.

The repeating unit cell, such as the structures shown in the dashed boxes in FIG. 1, may include any suitable number of alternating phase shifting elements. A repeating unit cell may include, for example, 1, 2, 3, 4, 5, 6, 7, 8, or more phase shifting elements. The unit cell has a dimension dx in the x axis and a dimension dy in the y axis, where the elements are arranged as arrays in the x-y plane. The resonating elements can be arranged to be periodic in at least one axis, such as the x-axis. When the number of phase shifting elements in a unit cell is one, the performance of the reflectarray may reduce to a mirror-like performance (specular). When the number of phase shifting elements in a unit cell is two or three, it might be difficult for the reflectarray to properly steer an incident RF beam, where instead of obtaining one reflected beam, the pattern of phase shifting elements may generate lots of scatterings in different directions. The RF reflection performance of a reflectarray may depend on the dimensions dx/m and dy/n, where m is the number of phase shifting elements in a unit cell in the x axis, and n is the number of phase shifting elements in a unit cell in the y axis. In the present disclosure, suitable dimensions dx/m and dy/n can be chosen such that λ/10<dy/m<λ, and λ/10<dx/n<λ, where λ is the free-space wavelength of a frequency of operation, i.e., the free-space wavelength of the wave incident on the reflectarray film.

To act as phase shifting elements, the resonating elements may include an array of periodic metastructures of suitable shapes. In the embodiments of FIG. 1, the phase shifting elements each have a “cross” shape. It is to be understood that a phase shifting element may include other shaped structures such as, for example, a ring shape, a “cross” or “plus sign” shaped structure, a “cross” structure disposed in the central region of a ring, a triangle shape, etc.

Each resonating element can have a wire-like or a patch-like structure, which can be formed by providing one or more metallic or high-k dielectric materials on the first major surface 132 of the dielectric layer 130. The resonating elements each may have a two dimensional geometric structure with a lateral dimension no greater than 4, where X is the free-space wavelength of a frequency of operation, i.e., the free-space wavelength of the wave incident on the reflectarray film. The resonating elements each may have a lateral dimension in a range, for example, from about 10 to about 50,000 micrometers. The wire-like resonating elements each may have a line width in a range, for example, from about 1.0 to about 50,000 micrometers, and a thickness of at least 5% of the skin depth thickness of selected metal within operating frequency range. The thickness of metallic resonating elements may be in a range, for example, from about 0.02 to about 100 micrometers. The wire-like resonating elements each have an aspect ratio of line-width versus thickness, for example, in a range from 0.1 to 2500. The thickness of high-k-dielectric resonating elements may be in a range, for example, from about 1.0 to about 100,000 micrometers.

The passive reflectarrays 142, 144, 152, 154 each performs beam splitting. A schematic diagram of the beam splitting behavior is shown in FIG. 6A. For example, a normal incident beam can be deflected to two reflecting directions θᵣ=±θ₁. As shown in FIGS. 4C-D, an incident beam from a station is deflected to users at opposite arms of a T-junction. A passive reflectarray to perform beam splitting can include rows of resonating elements having alternating row directions. As shown in FIG. 1, the resonating elements of the reflectarrays 142, 144, 152, 154 are arranged by alternating the reflectarray row directions. For example, when the resonating elements are arranged to be periodic in the x-axis, the largest element(s) of a unit cell is located directly adjacent to the smallest one(s) of the adjacent unit cell in the y-axis.

The passive reflectarrays 162, 164 each performs beam steering with an off-plane of incidence. A schematic diagram of beam steering with an off-plane of incidence is shown in FIG. 6B. The structure 162 features a n×n lattice unit cell that is made of n distinct elements, each row of which is shifted by one element to the right (left) with respect to the row below it. This structure can be characterized by an intrinsic property θ_{array}* that refers to the parameter, at which an incident wave with (θi=θarray*, φi=0°) and a reflected wave with (θr=θarray*, φr=90°) result in the maximum signal transmission (see, e.g., FIG. 6A). Note that a generic reflectarray (i.e., structures 110, 120, 130) that is composed of the same elements would result in reflectarray angle of θarray=θarray*. The structure 164, which adds a beam splitting performance to 162, consists of the multitude of patches featuring 162 structure and are stacked together forming a ‘checkerboard’ pattern, such that the phase gradients of any two neighbors are oppositely oriented.

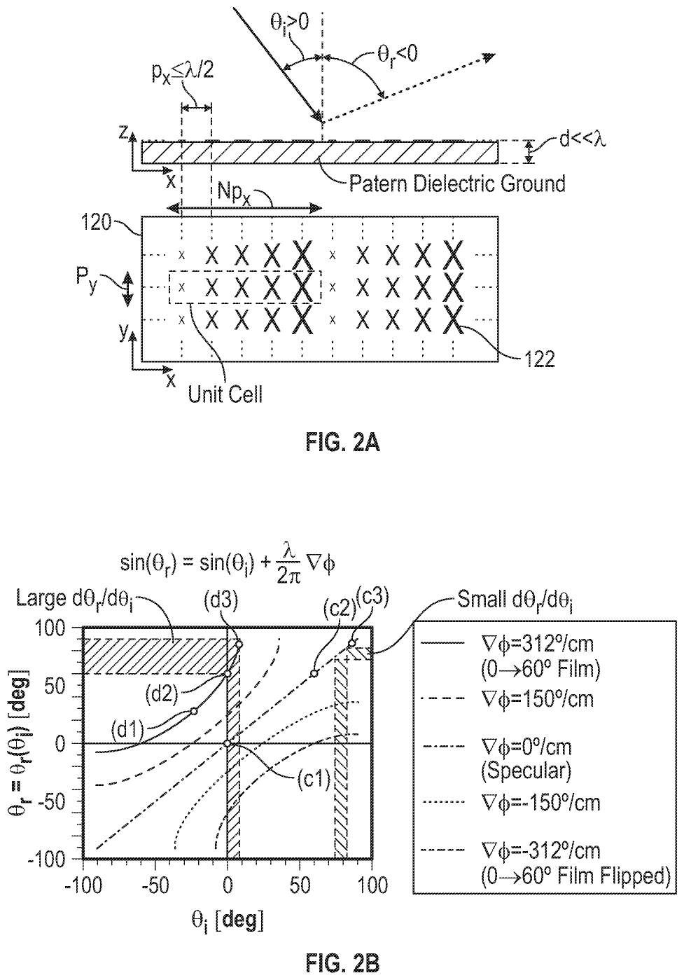

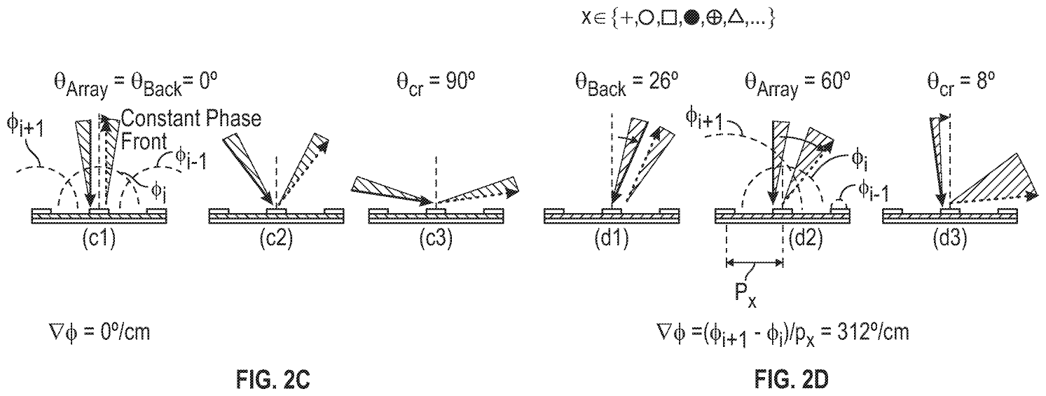

FIG. 2A illustrates a schematic cross-sectional view, and a top plan view of the reflectarray 120 of FIG. 1, along with introduced beam angle conventions. The reflectarray 120 includes a pattern of resonating metallic (or high-k dielectric) elements 122 disposed on a dielectric layer 124. FIG. 2B illustrates plots of reflection curves for the reflectarray 120 with different phase gradients 7. Here, the phase gradient refers to the intrinsic property of a constant phase gradient reflectarray that describes the maximum difference in phase advances that a normally incident electromagnetic wave exhibits upon reflection from two neighboring resonating elements (in the direction of largest phase variation, i.e., along the x-direction in FIG. 2 but in general, it can be along any direction) divided by the distance between their centers (px in FIG. 2). The phase gradient is related to the reflectarray angle via the relation θ_{cr}=sin⁻¹(|λ∇ϕ/2π|). For some structures such as the structure 120, the phase gradient along the y direction is zero, and the phase gradient parameter can be interchangeably referred to be the notations ∇ϕ and dϕ/dx. In accordance with the reflectarray angle, the phase gradient can be either positive or negative, depending on the direction of greatest phase increase (e.g., the increasing or decreasing sizes of elements along the x axis). FIGS. 2C and 2D depict the reflection behavior for typical specular reflectors (e.g., with the phase gradient dϕ/dx=0), and for constant phase gradient structures (e.g., with the phase gradient dϕ/dx=constant). The schematic diagrams (c1), (c2) and (c3) in FIG. 2C correspond to the points (c1), (c2) and (c3) in FIG. 2B, respectively. The schematic diagrams (d1), (d2) and (d3) in FIG. 2D correspond to the points (d1), (d2) and (d3) in FIG. 2B, respectively. The schematic diagrams (c1) in FIG. 2C and (d1) in FIG. 2D show back scattering condition (θᵢ=θᵣ=θ_{back}) corresponding to the critical angle θ_{back}=sin⁻¹(sin(θ_{array})/2)=sin⁻¹(|λ∇ϕ/4π|), where θ_{array} is the reflectarray angle, ∇ϕ is the phase gradient of the reflectarray, and λ is the free-space wavelength of the incident radiofrequency (RF) electromagnetic wave. The schematic diagram (d2) in FIG. 2D shows a characteristic for reflectarrays scenario of (θᵢ=0°, θᵣ=θ_{array}), i.e., steering a normally incident beam (with an incident angle about 0° with respect to a surface normal of the reflectarray film) by a reflecting angle θ_{array} away from the surface normal. The schematic diagram (d3) in FIG. 2D shows the scenario of reflected beam approaching a shallow angle (θᵢ=θ_{cr}, θᵣ=90°), with the critical condition at θ_{cr}=sin⁻¹(1−sinθ_{array})=sin⁻¹(1−|λ∇ϕ/2π|).

FIG. 2B indicates that at higher reflecting angles θᵣ, reflectarrays with sufficiently large phase gradients can significantly extend the range of beam sweeping (i.e., dθᵣ/dθᵢ>>1 for incident angles approaching θ_{cr} when the non-linear regime takes over). For example, for the reflectarray with a phase gradient ∇ϕ=312°/cm (which corresponds to θ_{array}=⁶⁰° for a frequency of 30 GHz), a small change of incident angle dθᵢ leads to a greater change of reflecting angle dθᵣ, e.g., from point d2 to point d3 in FIG. 2B. For specular reflectors (i.e., with phase gradient ∇ϕ=0°/cm), it remains unchanged (dθᵣ=dθᵢ).

In some embodiments, various basis sets of reciprocal beam propagation solutions are provided to enhance signals at Non-Line-of-Sight (“NLOS”) zones such as indoor L-junctions, T-junctions, four-way junctions, etc. The solutions are based on metalized films (with specular performance) and various reflectarrays such as 110, 120, 130, 142 and 144 in FIG. 1. The various mirror films and reflectarrays can be placed on walls at a junction. Optimized performance can be achieved by choosing the suitable reflectarrays with optimized characteristic for a given situation and active network placement. Such set arrangements can result in a number of technical advantages compared with their typical singular point-to-point use cases. One of such advantages is a better overall NLOS coverage. Another advantage of sets is their increased generality, i.e., they can serve a variety of angles of interest, so that various user demands can be satisfied with a finite number of Stock Keeping Units (SKUs), which simplifies their installation and minimizes a need for user-dependent customization. Such reflectarray combinations also feature an improved reciprocity (i.e., the location of a moving user and a fixed base station can be interchanged without compromises in the signal quality), and an increased number of available multipath signal components (hence, a less-likely connection drop when physical barriers are present). However, combining multiple reflectarrays may also generate additional losses such destructive self-interference (known as multipath distortion), increased free-space path losses, and substrate losses.

FIGS. 3A-E, 4A-D, 5A-B, and 6C are schematic diagrams of various indoor applications with a basis set of reflectarray films or panels at L-junctions, T-junctions, and four-way junctions, respectfully. For some solutions, the reversed data-receiving (RX) and data-sending (TX) scenarios are also depicted. The locations of schematically depicted base stations 2 and users 4 correspond to the focal points positions on the TX or RX side, respectively. As shown in FIG. 3A, metallic mirror films 32 are provided to reflect and direct signals from the base station 2 to the user 4 at an L-junction. As shown in FIG. 3B, two passive reflectarrays 110 of FIG. 1 are provided to reflect and direct signals from the base station 2 to the user 4 at an L-junction. As shown in FIG. 3C, a passive reflectarray 110 and a passive reflectarray 120 of FIG. 1 are provided to reflect and direct signals from the base station 2 to the user 4 at an L-junction for RX and TX scenarios. As shown in FIG. 3D, two passive reflectarrays 120 of FIG. 1 are provided to reflect and direct signals from the base station 2 to the user 4 at an L-junction. As shown in FIG. 3E, two passive reflectarrays 130 of FIG. 1 are provided to reflect and direct signals from the base station 2 to the user 4 at an L-junction. As shown in FIG. 4A, metallic mirror films 32 are provided to reflect and direct signals from the base station 2 to the user 4 at a T-junction. As shown in FIG. 4B, four passive reflectarrays 110 of FIG. 1 are provided to reflect and direct signals from the base station 2 to the users 4 at a T-junction. As shown in FIG. 4C, a passive reflectarray 152 of FIG. 1 is provided to reflect and direct signals from the base station 2 to the user 4 at a T-junction for RX and TX scenarios. As shown in FIG. 4D, passive reflectarrays 110 and 142 of FIG. 1 are provided to reflect and direct signals from the base station 2 to the user 4 at a T-junction for RX and TX scenarios. As shown in FIG. 5A, metallic mirror films 32 are provided to reflect and direct signals from the base station 2 to the user 4 at a four-way junction. As shown in FIG. 5B, four passive reflectarrays 110 of FIG. 1 are provided to reflect and direct signals from the base station 2 to the users 4 at a four-way junction.

In some embodiments, various metallized films, reflectarrays, and their combinations can be applied on ceilings, floors in addition to walls at L-junctions, T-junctions, and four-way junctions. The reflectarrays can be in any suitable shapes with any desired sizes. For example, for indoor applications, the reflectarrays can be in the form of panels with a length/width of 1 cm to 500 cm, and a thickness of 0.01 mm to 50 mm. The reflectarrays described herein can also be applied with other functional films or devices such as graphic films, adhesive films, flexible circuit films, etc.

As shown in FIG. 6, metallized films, reflectarrays (such as 110, 120 of FIG. 1) and reflectarrays with an off-plane of incidence are disposed on a ceiling 3 and a floor 5. The reflectarray 162 of FIG. 1 with an off-plane of incidence may be more suitable for L-junctions as it redirects the beam only in one direction (e.g., to the right direction in FIG. 6C). The reflectarray 164 of FIG. 1 with an off-plane of incidence may be more suitable for four-way junctions and T-junctions as it has an added beam splitting behavior, so can redirect beam in both directions (e.g., to the opposite left and right directions in FIG. 6C). The structure 164 has an added beam splitter, and it can serve both left and right directions (both of which are present in T- and four-way junctions). The structure 162, in contrast, can reflect only in one direction (as in L-junction, which only has a single direction turn anyways).

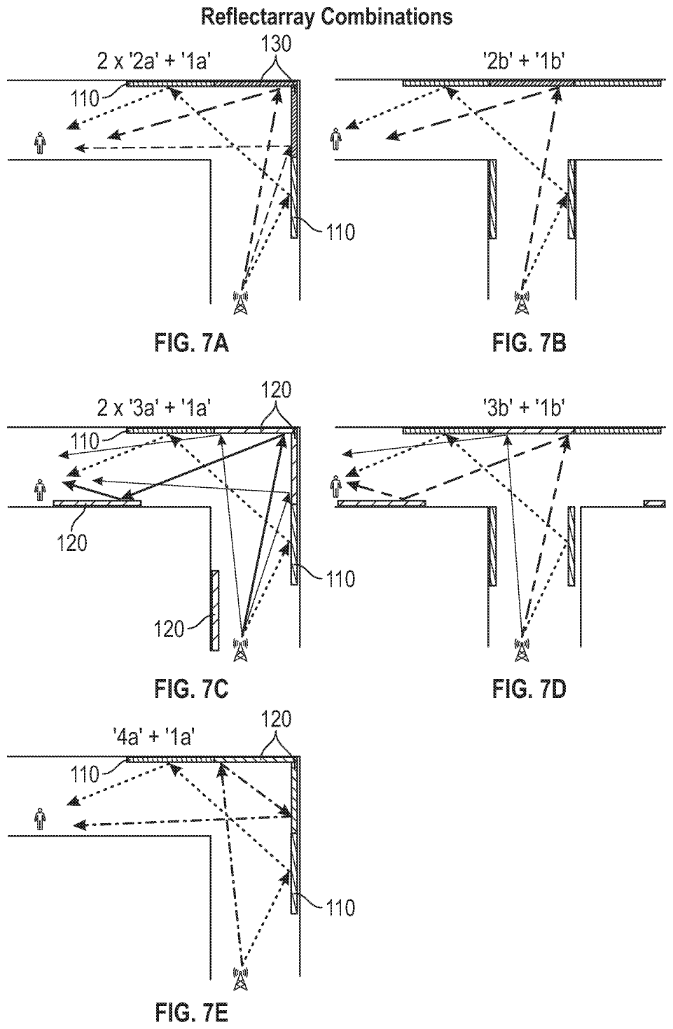

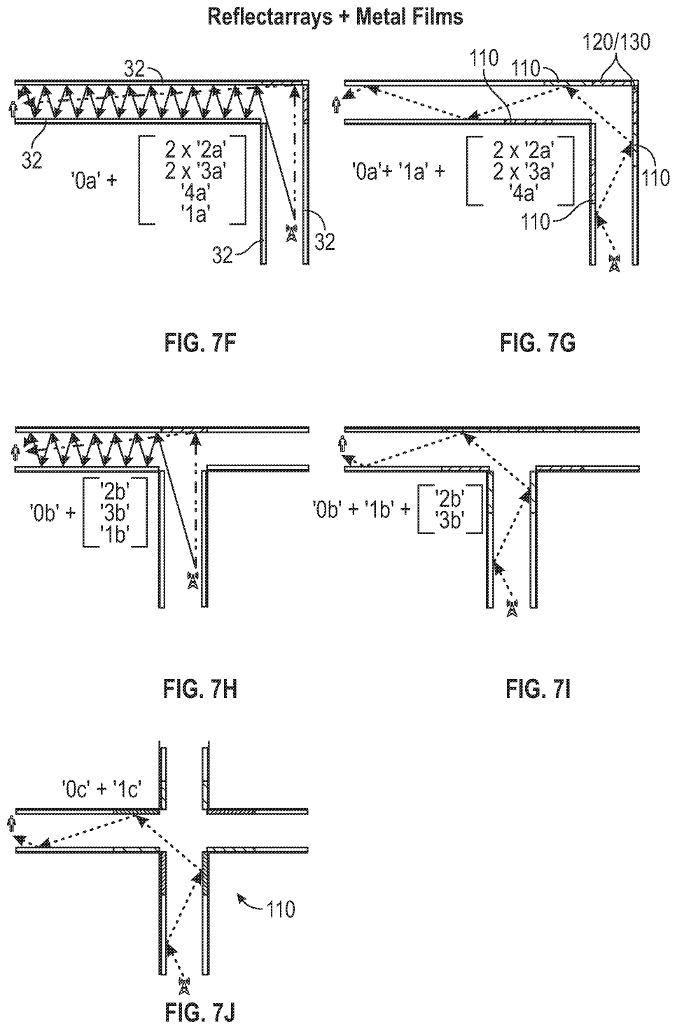

The various basis sets of reflectarrays shown in FIGS. 3A-D, 4A-D, 5A-B, and 6 can be combined to form complementary passive signal enhancers that create additional multipath components. FIGS. 7A-J illustrate various combinations of functional elements from the basis set described in in FIGS. 3A-D, 4A-D, 5A-B, and 6. The systems in FIGS. 7A-E include non-overlapping combinations of reflectarrays. The systems in FIGS. 7F-J further include combinations with metalized films. It is to be understood that the systems can be additionally combined with the ceiling and floor solutions such as the embodiments shown in FIG. 6C.

Various embodiments are provided that are reflectarray films, portions of the reflectarray films, methods of making at least a portion of the reflectarray films, and methods of using the reflectarray films.

In some embodiments, a passive signal enhancing system may include a first reflectarray and a second reflectarray, which can be selected from, for example, the reflectarrays illustrated herein such as in FIGS. 1, 3A-E, 4A-D, 5A-B, and 7A-J. At least one of the reflectarrays includes a pattern of repeating unit cells of resonating elements configured to reflect an incident radiofrequency (RF) electromagnetic wave at a wavelength λ in a range from about 1.0 mm to about 10.0 cm. Each resonating element includes a wire-like or a patch-like structure. The first reflectarray has a first phase gradient along a first longitudinal direction thereof. The second reflectarray has a second phase gradient along a second longitudinal direction thereof. The respective phase gradients can be in suitable ranges for desired applications. For example, the first phase gradient can be in the range from 5°/cm to 5,000°/cm. The second phase gradient can be in the range from 5°/cm to 5000°/cm. The first and second passive reflectarrays can be positioned to face to the incident RF electromagnetic wave with a first incident angle and a second incident angle, respectively.

In some embodiments, at least one of the first reflectarray and the second reflectarray delivers a non-linear steering performance. Reflectarrays that are based on constant phase gradient metasurfaces can exhibit non-linear behavior when the reflected angle approaches the critical angle θ_{cr} (as defined earlier), such that the derivative in the range of 1<|dθr/dθi|<Infinity.

In some embodiments, the combination of at least two reflectarrays delivers a linear steering performance. The linearity can be achieved via the opposite and net compensating effects of non-linearities present in each of the underlying reflectarrays. The embodiment depicted in FIG. 3D is such an exemplary structure including two reflectarrays in the L-junction, with sum of their reflectarray angles being in the range of 80°<|θ_{array,1}|+|θ_{array,2}|<100°.

In some embodiments, the at least one of the first reflectarray and the second reflectarray delivers a specular steering performance. The specular steering performance can be achieved via a metallic mirror film or any reflectarray or metasurface having uniformly arranged identical resonating elements, e.g., when the unit cell is comprised of a single resonating element.

In some embodiments, the at least one of the first reflectarray and the second reflectarray delivers a beam splitting performance. Beam splitting performance can be achieved when a reflectarray has a unit cell with a certain phase gradient and including two oppositely oriented sublattices (either with respect to the dimensions of the resonating elements or with respect to their underlying phase advances). The desired performance can be achieved when the element of the first sublattice that generates the smallest phase advance is located directly next to the element of the second sublattice that generates the largest phase advance (see, e.g., structures 142, 152 in FIG. 1). An alternative approach to reach a beam splitting behavior is to combine patches of regular reflectarrays (see, e.g., structures 144, 154 in FIG. 1).

In some embodiments, at least one of the plurality of passive reflectarrays is positioned on a vertical wall of a T-, L-, or four-way junction. At least one of the plurality of passive reflectarrays is positioned on a ceiling or a floor at a T-, L-, or four-way junction.

In some embodiments, at least one of the plurality of passive reflectarrays delivers an off-plane of incidence steering. Off-plane of incidence steering (more specifically, 90 degree turn of the incidence plane) can be achieved when the unit cell of the reflectarray (e.g., based on constant phase gradient structures) includes rows of resonating elements which are shifted to the left (to the right) with respect to their next nearest rows (either with respect to the dimensions of the elements or with respect to their underlying phase advances). For example, the second reflectarray can be designed to steer the incident beam with an off-plane of incidence, where the resonating elements of the second reflectarray can be arranged such that every subsequent row of the pattern is shifted with respect to an underlying row by a fixed number of elements to the left (right). Structures 162, 164 of FIG. 1 are exemplary structures for performing an off-plane of incidence beam redirection.

In some embodiments, the incident RF electromagnetic wave is from a network featuring adaptive beamforming on transmitting and/or receiving ends (within “Single-input, single-output” or SISO, “Multiple-input, single-output” or MISO, “Single-input, multiple-output” or SIMO, “Multiple-input, multiple-output” or MIMO, “Multi-user, multiple-input, multiple-output” or MU-MIMO communication networks) At least one of the nodes of the network is capable of adaptive beamforming (i.e., spatial filtering). All the proposed earlier reflectarrays schemes can still work as in regular broadcast-type networks.

In some embodiments, a system of enhancing non-line-of-sight (NLOS) signal for wireless communications may include one or more passive reflectarrays. At least one of the reflectarrays includes a pattern of repeating unit cells of resonating elements configured to reflect an incident radiofrequency (RF) electromagnetic wave at a wavelength λ in a range from about 1.0 mm to about 10.0 cm, each resonating element comprising a wire-like or patch-like structure. The one or more passive reflectarrays include at least one of a first reflectarray configured to split an incident beam and a second reflectarray configured to steer the incident beam with an off-plane of incidence. The first reflectarray and the second reflectarray, which can be selected from, for example, any suitable reflectarrays illustrated herein such as in FIGS. 1, 3A-E, 4A-D, 5A-B, and 7A-J. In some embodiments, the resonating elements of the first reflectarray rows are arranged with alternating row directions. In some embodiments, the resonating elements of the first reflectarray rows are arranged in a checkerboard pattern. In some embodiments, the resonating elements of the second reflectarray are arranged such that every subsequent row of the pattern is shifted with respect to an underlying row by a fixed number of elements.

### EXAMPLES

These examples are merely for illustrative purposes and are not meant to be limiting on the scope of the appended claims.

### Modeling Process

A modeling process was utilized to model reflectarray articles, including (i) performing preliminary electromagnetic simulations with the CST Studio Suite Software (commercially available from Dassault Systèmes Company, WALTHAM, MA, U.S.A.), (ii) application of Ray optics approximation theory (see, Ö. Özgecan, et al., IEEE Wireless Communications Letters 9.5, (2019)), and (iii) the verification of far field performance using a reflectarray theory (see, J. Huang, “Reflectarray Antennas”, IEEE (2007)).

### Characterization

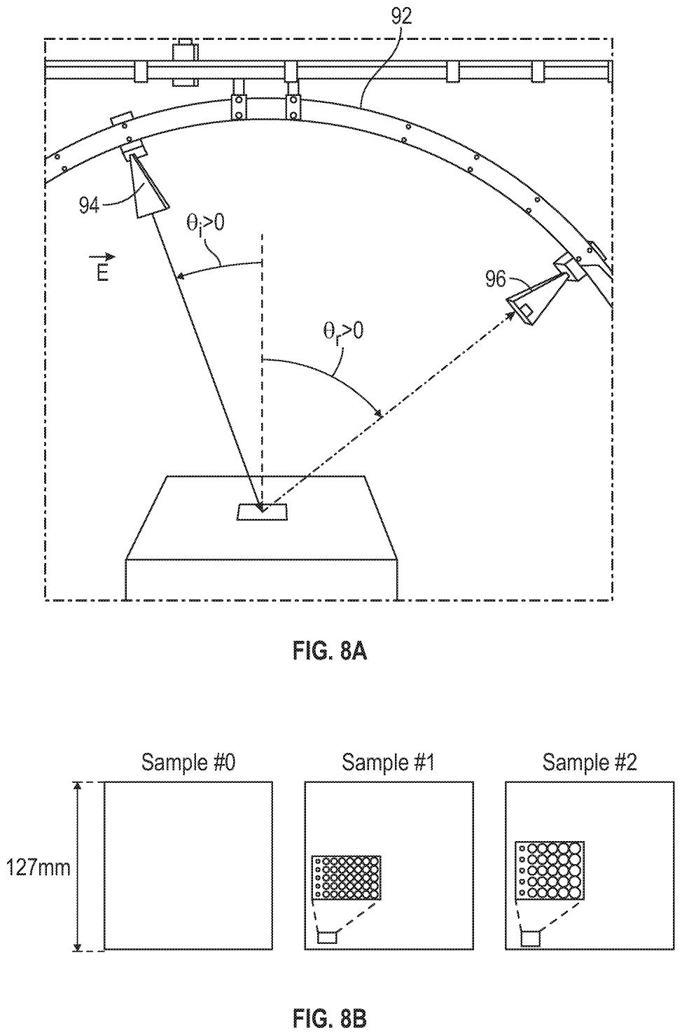

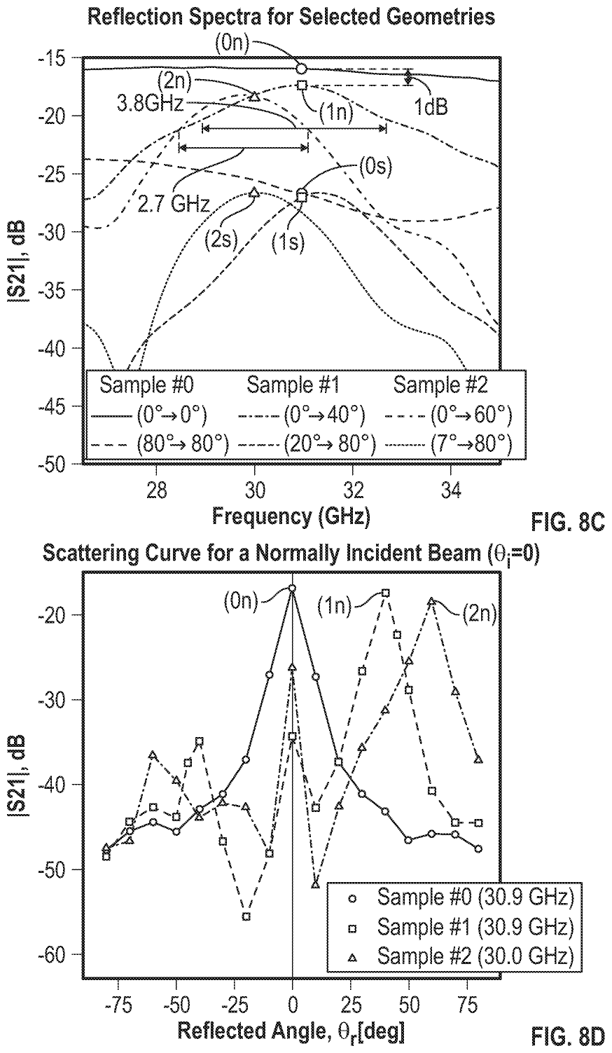

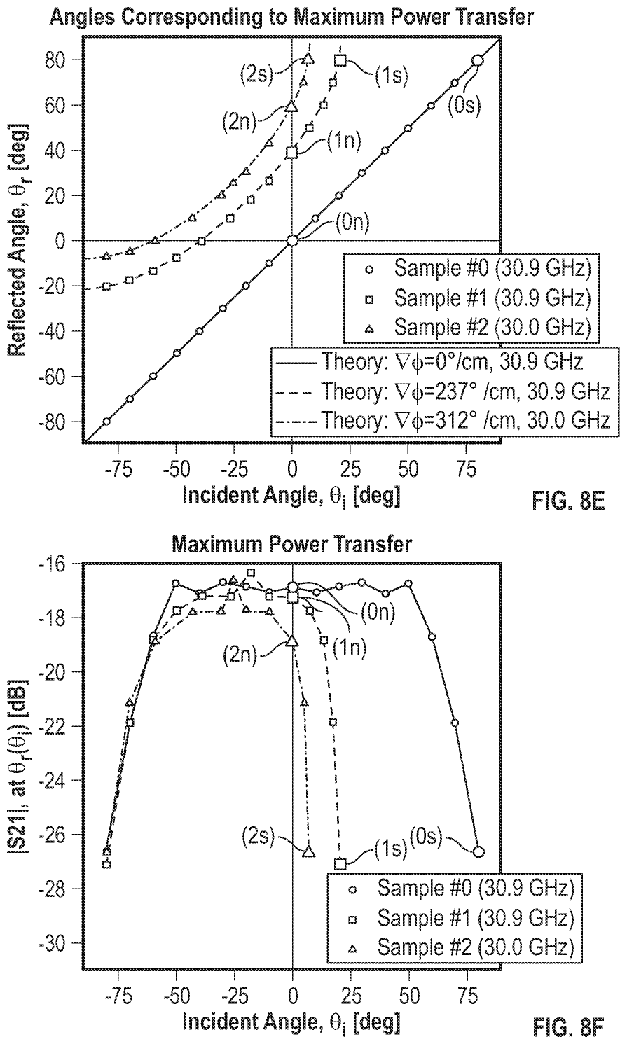

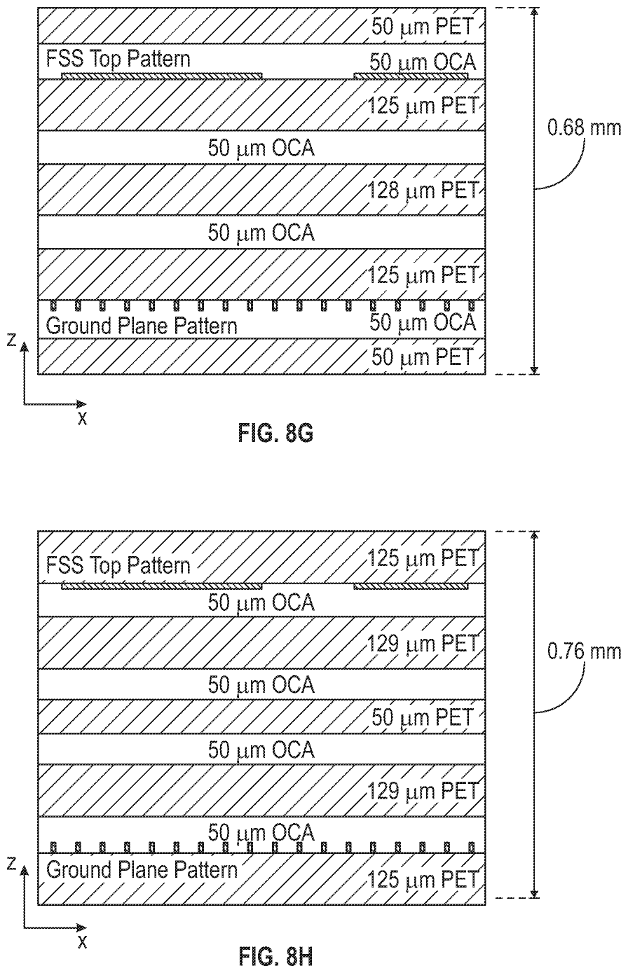

The beam steering performance of various reflectarray films of various Examples were characterized using a custom-built arc setup as shown in FIG. 8A. The RF mirror is a 38-micrometer thick aluminum foil glued on top of 5-micrometer thick foam. As shown in FIG. 8A, the arc 92 consists of a semi-circle having a 0.8-meter radius. Transmitter and receiver horn antennas 94, 96 were independently positioned at various angles along the arc 92 to record reflected beam intensity as a function of frequency. The transmitter and receiver horns 94, 96 were ERAVANT WR-28 Standard Gain Horn Antennas. They were connected to the two ports of a vector network analyzer (Agilent Technologies E836C).

### Examples 0, 1 and 2

Examples including specular reflectors (Example 0 as a benchmark) and reflectarrays (Examples 1 and 2) were prepared. Reference Example 0 is a 12.7 cm×12.7 cm, 38-micrometer-thick flat aluminum mirror. Examples 1 and 2 are reflectarrays that are based on the constant phase gradient metasurfaces having a phase gradient of dφ/dx=237°/cm for Example 1 (312°/cm for Example 2) and the lattice period of 1.90 mm for Example 1 (1.93 mm for Example 2). Table 1 below summarizes the descriptions for Examples 0, 1 and 2.

The top plan view of Examples 0, 1 and 2 is shown in FIG. 8B. Example 0 was glued on top of a 5-micrometer thick foam. The laminated film cross sections for Example 1 (“0 to 39 degree array”) is shown in FIG. 8G. The laminated film cross sections for Example 2 (“0 to 60 degree array”) is shown in FIG. 8H. Example 1 has the total thickness of 0.68 mm and consists of the ground and FSS layers patterned on top of 125-micrometer-thick PET layers, which are turned inwards and separated by a dielectric stack made of one 128-micrometer-thick PET layer and two optically clear adhesive (OCA) layers. For outer protection of grounds and patterns, the extra 50-micrometer-thick PET and 50-micrometer-thick OCA layers are added on both sides of the stack. Example 2 has the total thickness of 0.76 mm and consists of the ground and FSS layers patterned on top of 125-micrometer-thick PET layers (which also serve as outer protection layers) that are separated by a dielectric laminate, which is made of two 129-micrometer-thick PET films and one 50 um PET film, all of which are separated by four layers of 50-micrometer-thick OCA.

TABLE 1

| Abbreviation | Description |
|---|---|
| Example 0 | A reference passive reflector, which is a 38 um aluminum foil glued |
| | on top of 5 um foam. Finished samples were 12.7 cm by 12.7 cm in |
| | dimension (used as a reference for measurements on a custom-built |
| | arc-setup). For L-junction measurements in a hallway, a 2 mm-thick |
| | flat sheet of aluminum was used (96.8 cm by 96.8 cm) |
| Example 1 | Semi-transparent array that preferentially reflects a 30.9 GHz RF beam |
| “0 to 39 | from an incident direction normal (90 degrees) to the film plane to a |
| degree array” | direction that is 39 degrees from the normal direction (or 51 degrees |
| | from the film plane). Finished samples were 12.7 cm by 12.7 cm in |
| | dimension. |
| | For L-junction measurements in a hallway, two 76.8 cm by 40.1 cm |
| | samples were used, which were assembled from twelve 25.4 cm 20.3 |
| | cm sheets flattened on FR-4 substrates with a spray adhesive. |
| Example 2 | Semi-transparent array that preferentially reflects a 30 GHz RF beam |
| “0 to 60 | from an incident direction normal (90 degrees) to the film plane to a |
| degree array” | direction that is 60 degrees from the normal direction (or 30 degrees |
| | from the film plane). Finished samples were 12.7 cm by 12.7 cm in |
| | dimension. |

### Fabrication Steps

The following fabrication steps were used to make Examples 1 and 2. It is to be understood that similar steps can be used to make various reflectarrays such as the reflectarrays shown in FIG. 1. Each sample had two copper patterned layers: resonator structures in the form of a ring pattern, and a ground plane in the form of a uniform grid pattern. Film substrate was prepared by sputter coating a tie layer and copper seed layer onto an optical grade, heat stabilized PET film. The patterned resonator structures and ground plane grid patterns were prepared by electroplating the sputtered/seeded film substrate with 5 microns of copper. The exposed copper was then vacuum laminated with a layer of photoresist. The photoresist was exposed by laser direct imaging and then the unexposed regions were developed. The patterned photoresist served as a mask in a copper etching step using a cupric chloride etchant, followed by an electroless tin finish plating.

The functional reflectarray films were prepared by roll laminating interposing film layers between a patterned resonator film and a ground plane film using an optically clear adhesive (OCA). The ground plane mesh patterns for the 60-degree and 39-degree samples were identical. The mesh layer had a square repeat unit with a period of 192 microns and a trace width of 40 microns. The dimensions for resonating ring (labeled “a” through “f”) of Example 2 (the “0 to 60 degree array”), and resonating ring (labeled “a” through “h”) of Example 1 (the “0 to 39 degree array”) are given in the following Table 2. In both samples, all rings have a trace width of 40 microns. The polyester terephthalate (PET) film is commercially available under the trade designation of MELINEX ST-504 from Tekra, New Berlin, WI. The optically clear adhesive (OCA) is commercially available under the trade designation of 3M 8212 optically clear adhesive from 3M Display Materials and Systems, Oakdale, MN.

TABLE 2

| | Example 1 | Example 2 |
|---|---|---|
| Ring | Diameter (mm) | Diameter (mm) |
| a | 0.810 | 0.874 |
| b | 1.440 | 1.548 |
| c | 1.512 | 1.619 |
| d | 1.546 | 1.660 |
| e | 1.572 | 1.703 |
| f | 1.603 | 1.807 |
| g | 1.651 | |
| h | 1.762 | |

Each ring in the reflectarray unit cell has been assigned a specific diameter (listed in Table 2 for Examples 1 and 2) such that it generates a phase response that (as defined up to an arbitrary additive constant) incrementally increases from 360/n degrees for the first ring (which is 360/6=60 degrees for Sample 2 and 360/8=45 degrees for Sample 1) up to 360 degrees for the last ring of the unit cell, where n is the number of rings for each row in the unit cell. This translates to the phase gradient of 311.7 deg/cm for Sample 2 and 237.1 deg/cm for Sample 1 (this, in turn, translates to the lattice periods of dx=6 dy, dy=1.925 mm for Sample 2 and dx=8 dy, dy=1.898 mm for Sample 1). Finally, using the Generalized Snell's Law, sin(θr)=sin(θi)+grad(φ)*λ/2π, where grad(φ) is the phase gradient, for the operating frequencies of 30 GHz (Example 2) and 31.1 GHz (Example 1), this leads to the 0 to 60 degrees (Example 2) and 0 to 39 degrees (Example 1) beam steering performance.

### Characterization

The beam steering performance of various reflectarray films of Examples 1 and 2, and a 12.7 cm RF mirror were characterized using a custom-built arc setup as shown in FIG. 8A. FIG. 8C illustrates plots of reflection versus frequency curves for Examples 0, 1 and 2. The samples were placed in the center of the arc. The distance between the center and the horns is 0.8 m, which corresponds to the far-field measurements for the used in the measurements Ka-band horns. Such distance also results in a sufficiently planar wavefront as long as the sample is no larger than 12.7 cm. Solid lines correspond to 0°→θ₁ geometries, where θ₁ were chosen in the proximity of pre-modeled parameters, which yielded maximum signal at about 30 GHz. Dashed lines correspond to the end-fire angle combinations, which were chosen by extending the Generalized Snell's law from the corresponding 0°→θ₁ points (at frequencies where they reached maxima) to shallower reflected angles. FIG. 8D illustrate scattering curves plotted at frequencies corresponding to the best performance of selected 0°→θ₁ geometries. FIG. 8E illustrates plots of reflected angle θᵣ versus incident angle θᵢ, where the combinations of θᵢ, θᵣ result in the maximum reflected signal (for frequencies chosen at FIG. 8C). The corresponding signal strength versus incident angle plotted are plotted in FIG. 8F. In FIGS. 8C-F, the common six data points were highlighted, where (‘i’n)—denotes a normal incidence case (i.e., 0°→θ₁) and (‘i’s)—a shallow reflected angle case for Example i.

The plots in FIGS. 8D-F were further explained below. First, the optimal characteristics of reflectarrays of Examples 1 and 2 were determined. The pre-fabrication modeling results were obtained by CST, which yielded 0°→45°@27.9 GHz and 0°→60°@30 GHz for Examples 1 and 2, respectively. After performing the 0°→θ scan, the optimum θ₁ was determined that resulted in the largest reflectivity nearby the frequencies of interest. This procedure yielded the optimal values of 0°→40°@30.9 GHz and 0°→60°@30 GHz for Examples 1 and 2, respectively, with the corresponding curves plotted in FIG. 8C with solid lines. The best performance of about −16 dB is achieved by the Al mirror of Example 0 in specular geometry, while Examples 1 and 2 yielded about −17 dB and about −18 dB respectively. Also, unlike Example 0, which has a relatively flat spectrum, Examples 1 and 2 have a finite (about 3 dB) bandwidth of 12.3% and 9%, respectively. These values are within the specs of current 5G standards, e.g., n261 and n260 bands (which have bandwidths of 3% and 7.8% at their respective frequencies).

Next, for the chosen 0°→θ₁ reflectarray geometries, the amount of signal that is lost to other diffraction orders was determined. For this, the angle of an incident beam to normal orientation was fixed to perform the scan of the reflected angles in a range from 0° to 80°. The resulting scattering curve is plotted in FIG. 8D with points representing the experimental data and dashed lines that guide the eye. The largest signal leakages of −9 dB (Example 2) and −17 dB (Example 1) occur for a specular direction (0°→0°), followed by a −17 dB leakage (for both samples) in the 0°→−θ₁ direction. Indeed, for subwavelength reflectarrays such as Examples 1 and 2 (e.g., lattice period is less than λ/5), the only possible scattering alternatives are either the 0^{th} order specular reflection (0°→0°) or the −1^{st} order non-specular reflection (0°→−θ₁). For Examples 1 and 2, such losses turned out to be are relatively small, so the chosen 0°→θ₁ geometries are indeed close to being optimal.

When the optimal 0°→θ₁ configurations are established, it has been verified that the fabricated examples follow the so-called Generalized Snell's law for a wide range of incident angles. To do this, for every incident angle of choice one needs to determine the reflected angle that results in the maximum achieved reflection, where the frequencies are kept constant). The resulting data points, plotted with dots in FIG. 8E, are in very strong agreement with the theoretical Snell's law (assuming frequencies and phase gradient values given by the specs of the fabricated samples) plotted in solid lines. Different parts of the curve in FIG. 8E lead to a different amount of a transferred power, as is clear from FIG. 8F that plots the corresponding S₂₁ parameter as a function of an incident angle (with the reflected angle chosen according to the Snell's law in FIG. 8E). One can find that the maximum amount of power is always achieved in the backscattering direction (see, e.g., (c1) and (d1) in FIG. 2C), steadily dropping as the reflected angle becomes shallower, reaching the drop of about 10 dB at θᵣ about 80°. The bandwidth at shallow reflected angles also depresses somewhat, dropping to about 8% at θᵣ about 800 as is depicted in FIG. 8C with dashed lines.

The fabricated reflectarrays (e.g., Examples 1 and 2) work efficiently and in full agreement with the Generalized Snell's law. For this reason, they can be viewed as valid functional blocks for building more complex designs such as the ones proposed in FIGS. 3A-D, 4A-D, 5A-B and 6.

### Examples 3, 4 and 5

Examples 3-5 were fabricated to demonstrate reflectarrays that perform beam splitting (such as in reflectarrays 142, 144, 152 and 154 of FIG. 1) and beam steering with an off-plane of incidence (such as in reflectarrays 162 and 164 of FIG. 1). One straightforward way to add a beam splitting functionality to regular reflectarrays (i.e., with normal beam deflecting to two directions, θᵣ=±θ₁) is to stack reflectarrays into multiple sheets such that all neighboring sheets have the opposite sense of orientation. This approach requires the size of each sheet be appropriate, neither too small (as this will lead to signal deterioration due to destructive interferences from neighboring sheets) nor too large (as this will lead to the domination of single reflections rather than to a beam splitting).

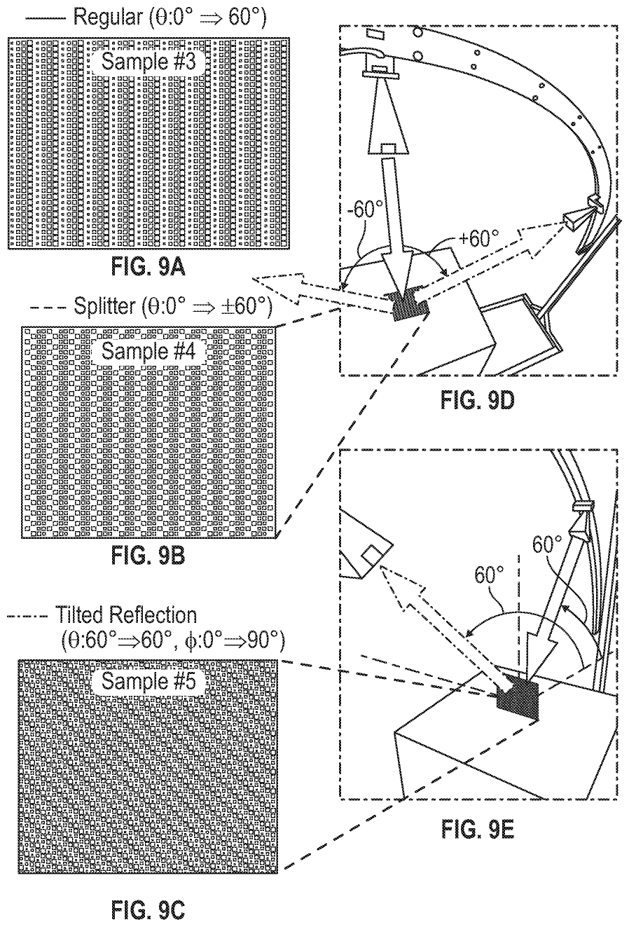

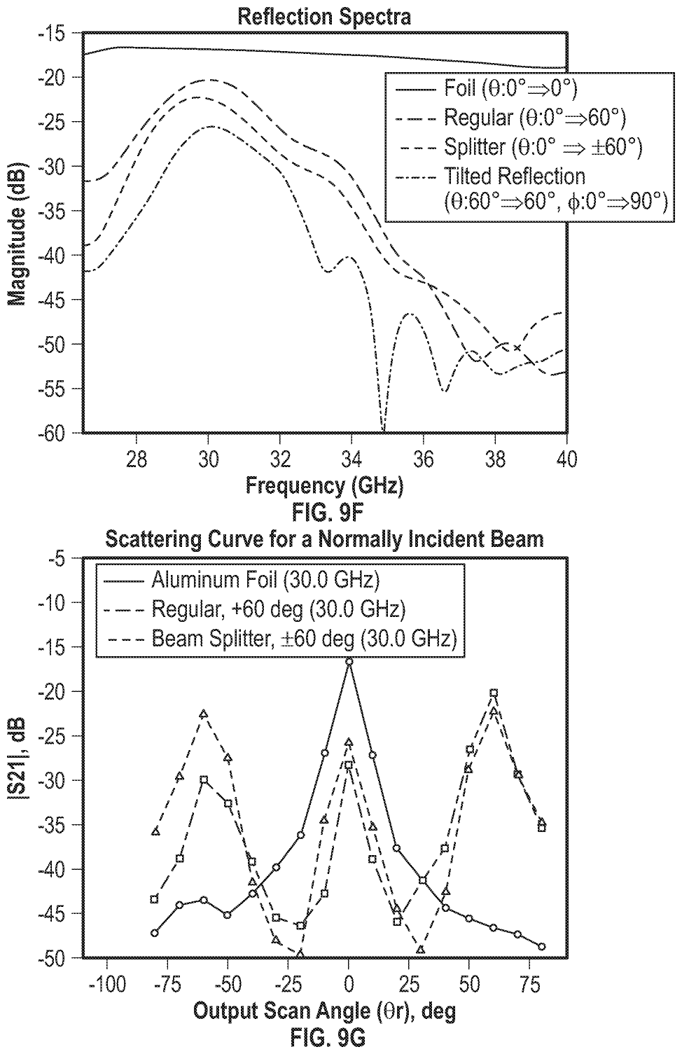

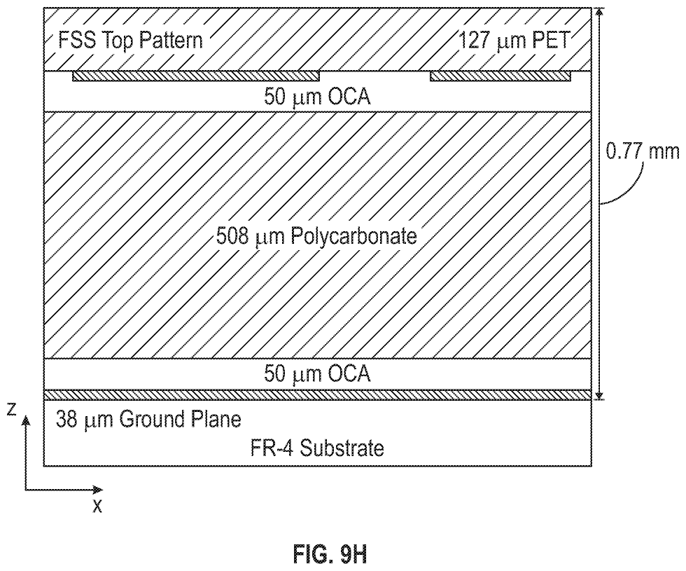

From the numerical reflectarray theory (Huang & Encinar, 2008), it is found in this disclosure that in order to eliminate destructive interference effects, the rows must be oriented in such a way that every largest element is located directly underneath the smallest one such as shown in the reflectarrays 142, 144, 152 and 154 of FIG. 1. Example 4 is an example of such beam splitter with θ: 0->±60° functionality (see FIGS. 9B and 9D), with its properties denoted in FIGS. 9F and 9G in yellow. For reference, the performance of Example 4 is compared with that of Example 3 having a typical 0->+60° structure that was constructed from the same unit cell elements (see FIG. 9A, and purple lines of FIGS. 9F and 9G). Note that beam splitter is about 2 to 3 dB worse than a typical reflectarray, which is in line with the fact that it is effectively, a power divider.

To achieve the off-plane of incidence steering at junction floors/ceilings (depicted with green arrows in FIG. 6), one can use a more general reflectarray equation (Huang & Encinar, 2008), which after applying the condition φᵢ=0°, φᵣ=900 results in the following phase distribution:

$$sin ( {θ}_{r} ) = - \frac{λ}{2 π} \frac{\partial φ}{\partial x} , sin ( {θ}_{i} ) = - \frac{λ}{2 π} \frac{\partial φ}{\partial γ} , \qquad ( 1 )$$

For cases of identical incident and reflected angles, θᵢ=θᵣ=θ₁* (which is still relevant for the junctions described herein), this reduces to a simple lattice schematically visualized as the reflectarray 162 in FIG. 1. The only disadvantage of this type of reflectarray is that it transforms a TE polarized RF beam into a partially polarized TM-beam (and the other way around), which leads to a somewhat less efficient signal transfer. However, modern mobile phones typically have antennas that are sensitive to two beam polarizations, so there will always be at least some amount of present signal. Example 5 is an example of such reflectarray with an off-plane of incidence with θ:60°->60°, φ: 0°->90° functionality (FIGS. 9C and 9E), with its spectra corresponding to the optimal angular configuration depicted in FIG. 9F in red. The reflectarray of Example 5 has a pattern 162 depicted in FIG. 1 (but with 4×4 elements in the unit cell).

The laminated film cross sections for Examples 3-5 are shown in FIG. 9H. Each sample has the total thickness of 0.77 mm and consists of the 38-micrometer-thick Cu ground and FSS layers patterned on top of 127-micrometer-thick PET layers (which also serves as an outer protection layer) that are separated by a 508-micrometer-thick polycarbonate (PC) film sandwiched between two 50-micrometer-thick OCA layers. Brief descriptions for Examples 3, 4 and 5 are also listed in Table 3 below. The PC film is commercially available under the trade designation of #38-20F-GG from CS Hyde Company, Lake Villa, IL.

TABLE 3

| Abbreviation | Description |
|---|---|
| Example 3 | Non-transparent array that reflects a 30.0 GHz RF beam from an |
| | incident direction normal (0 degrees to the normal direction) to a |
| | direction that is 60 degrees from the normal direction. Finished |
| | samples were 12.7 cm by 12.7 cm in dimension. |
| Example 4 | Non-transparent array that reflects a 30.0 GHz RF beam from an |
| | incident direction normal (0 degrees to the film plane) to a direction |
| | that is ±60 degrees from the normal. Finished samples were 12.7 cm |
| | by 12.7 cm in dimension. |
| Example 5 | Non-transparent array that reflects a 30.0 GHz RF beam from an |
| | incident direction (θ = 60°, φ = 0°) to a direction that is (θ = 60°, |
| | φ = 90°) from the normal direction. Finished samples were 12.7 cm |
| | by 12.7 cm in dimension. |

### Fabrication Steps

The following fabrication steps were the same for Examples 3-5. Each example had a thin Al pattern layer with resonator structures in the form of a square patches, and a ground plane in the form of 38-micrometer-thick copper.

Film substrates were prepared by evaporate-coating a Ti (5 nm) seed layer onto an optical grade, heat stabilized PET film. The patterned resonator structures were prepared by depositing the evaporated/seeded film substrate with 150 nm of Aluminum. The patterning process is based on a proprietary technique that has a feature resolution of less than about 0.1 mm.

The functional reflectarray films were prepared by roll laminating interposing film layers between a patterned resonator film and a ground plane film using an OCA. The ground plane mesh patterns for all samples were identical and based on a 1 oz copper (from single-layer FR-4 boards). The dimensions for resonating square patches (labeled “a” through “d”) of Examples 3-5 are given in the following Table 4.

TABLE 4

| | Examples 3-5 |
|---|---|
| Square | Lateral size (mm) |
| a | 0.4217 |
| b | 1.7939 |
| c | 2.0208 |
| d | 2.4684 |

Each square in the reflectarray unit cell has been assigned a specific size (listed in Table 4) such that it generates a phase response that (as defined up to an arbitrary additive constant) incrementally increases from 360/n degrees for the first ring (which is 360/4=90 degrees) up to 360 degrees for the last ring of the unit cell, where n is the number of rings in the unit cell. This translates to the phase gradient of 311.7 deg/cm (this, in turn, translates to the lattice periods of dx=4dy, dy=2.887 mm). Finally, using the Generalized Snell's Law, sin(θr)=sin(θi)+grad(φ)*λ/2π, for the operating frequencies of 30 GHz this leads to the 0 to 60 degrees beam steering performance. Examples 3, 4 and 5 have their respective patterns corresponding to the lattice patterns 120, 142, and 162 of FIG. 1. The differences between Examples 3-5 are only in their lattice arrangements along the y direction as depicted in FIGS. 9A-C.

### Example 6: A Basis Set of Reflectarrays at an L-Junction

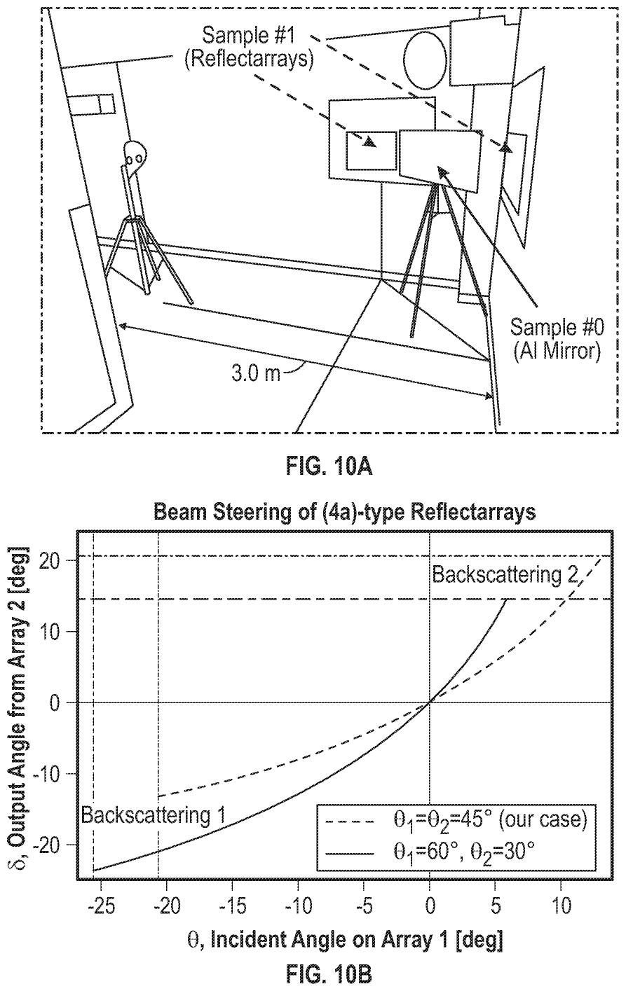

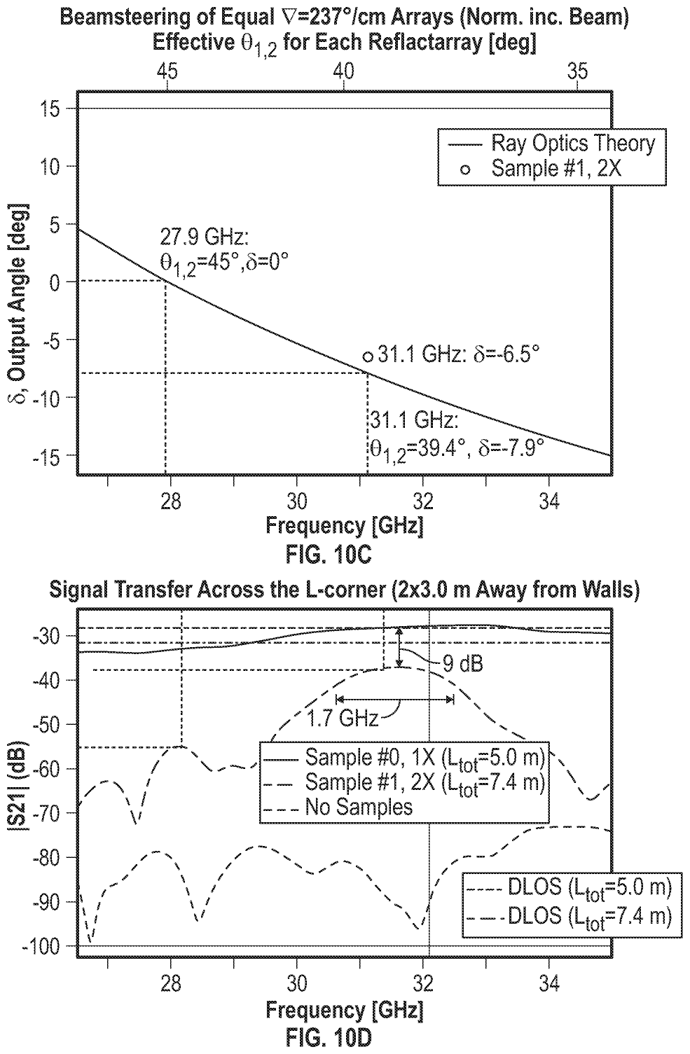

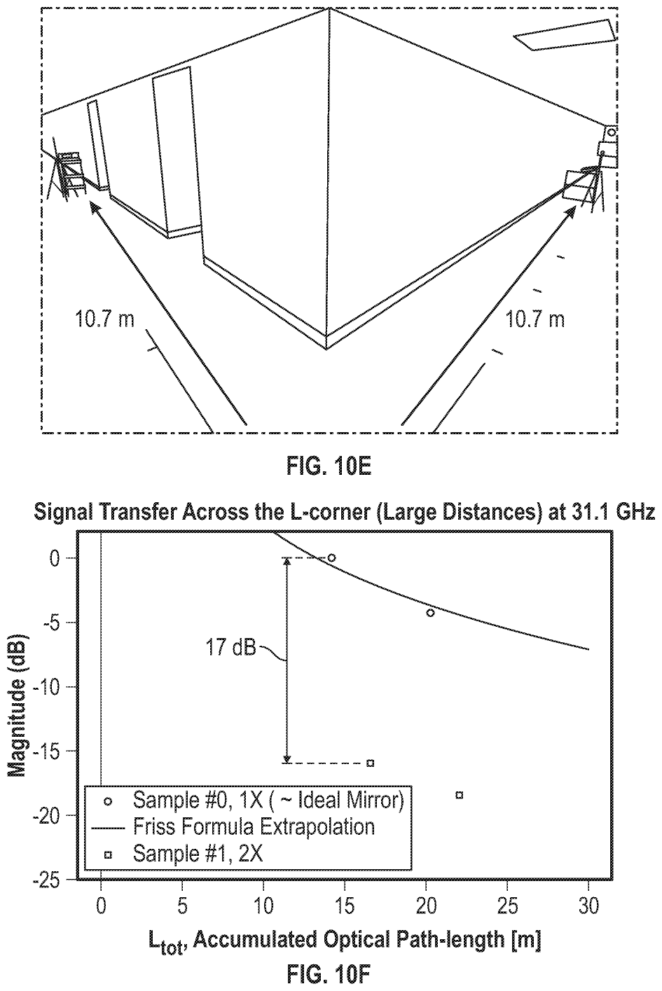

In Example 6, multiple reflectarrays are disposed at an L-junction according to the configuration shown in FIG. 3D. The performance of the multiple reflectarrays was tested when they are combined into a beam steering configuration. Here, an L-corner inside a building was chosen as a testing environment, which is depicted in FIG. 10A. Multiple reflectarrays of Example 1 were combined into two large 76.8 cm by 40.1 cm stacks (Assay 1 and Array 2), which were then placed on both walls of the L-junction. Although such structures wound up being optimal for 0°→40° rather than 0°→45° beam re-direction performance, the structures still work well as a whole and within the prescribed earlier reflectarray angle ranges for, 80°<|θ₁|+|θ₂|<100°. (for θ₁, θ₂ angle definitions see the inset of FIG. 3D). The performance of these arrays is compared against a specular performance of a flat aluminum sheet (i.e., Reference Example 0), which has the size of 96.8 cm by 96.8 cm (its 45° projection is comparable to the dimensions of Array 1 or 2).

First, the expected beam steering performance for an idealized configuration/system as shown in FIG. 3D was determined. Using a basic ray optics theory, one can find that the output angle S of this system depends on the off-normal input angle θ (as visualized in the inset of FIG. 10B) in the following equation (2):

$$sin δ = \qquad ( 2 )$$

$$cos {θ}_{1} sign θ [ 1 - \sqrt{1 - \frac{sin θ ( 2 sin {θ}_{1} + sin θ )}{{cos}^{2} {θ}_{1}}} ] ∼ tan {θ}_{1} sin θ + O ( {sin}^{2} θ )$$

where δ is the reflection angle (with respect to reflectarray 2, which has the characteristic reflectarray angle θ_{array}=θ₂) in response to the incident beam at an angle θ (with respect to reflectarray 1, which has the reflectarray angle θ₁). The beam-steering angles of Array 1 and Array 2 are related roughly as θ₂=90°−θ₁ such as depicted in FIG. 3D. The resulting curves for various θ₁, θ₂ combinations are depicted in FIG. 10B, where output angle versus incident angle for different reflectarray combinations is depicted as predicted with the Ray optics theory. As shown in FIG. 10B, the vertical (horizontal) lines correspond to the shallow angle threshold condition reached at Array 1 (Array 2). A symmetric θ_{1,2}=45° combination shows a unitary response, δ˜θ+0(θ²) (depicted in blue in FIG. 10B), while an asymmetric one is linear, δ˜θ tan(θ₁)+0(θ²) (depicted in black in FIG. 10B for 01=60°, θ₂=60°). The simulation results show that the actual ranges of δ and θ are limited by the geometric constraints of the system, rather than by the backscattering or shallow angle conditions, coupled with a large off-center displacement of beams that are incident on Array 2. For this reason, the effective working area of Array 1 is typically about 50% at close distances (e.g., at distances about 2× the width of the hallway), and it becomes more efficient when the TX/RX side is further away from it.

Since the optimal angle of the reflectarrays in Array 1 or 2 is 40° rather than 450 (and it does not add up to 90° as was prescribed in FIG. 3D), the actual output angle of Example 6 was evaluated as a function of frequency when the input beam is normally incident (as is visualized in FIG. 3D, considering the case of x=0, i.e., θ₁=θ₂=45°). For this, the ray optics and reflectarray theory was used to arrive at the curve plotted in FIG. 10C, which illustrates plots of output angle versus frequency for Example 6 composed of multiple Example 1, with incident beam strictly normal. Extra x-axis (in green) denotes the effective reflect array parameters for a resulting ((0→θ₁), (0→θ₂)) system with θ₁=θ₂=θ_{1,2}. The reflectarray of Example 6 has originally been designed for 27.9 GHz, and at this frequency the output angle is δ=0°. As indicated by the single reflectarray spectra in FIG. 8C, the amount of the signal that can actually be transferred at this frequency is very small. In contrast, for the optimal performance frequency of about 31 GHz, the expected steering angle was observed to shift to δ=−8°. This simulation result is in close agreement with the actual data point of δ=−6.5°, which was found when two horn antennas (connected to a network analyzer) were placed about 10-feet (3.05 m) away from the reflectarrays, such that an incident angle was fixed at θ=0° but the receiver was moved off-center until the signal maximum has been achieved (at 31.1 GHz).

FIG. 10D depicts the total reflection spectrum of reflectarray that was recorded using a network analyzer. Notably, the band center of the system of Example 6 moves by about 0.5 GHz to the right compared to that for a single reflectarray of Example 1 (see, the blue solid line in FIG. 8C). The 3 dB bandwidth also drops from 12.3% reached by single reflectarray to about 5.4%, which is likely a consequence of a larger reflectarray area (Huang & Encinar, 2008) as well as of their mutual near-field interactions. It was observed that removing samples leads to a signal drop of about 50 dB (as is shown in yellow), i.e., L-junctions are almost impenetrable for mm-wave-signal. In contrast, the placement of aluminum mirror in specular geometry leads to a signal (depicted in green) that is comparable to the Direct Line of Sight (DLOS) case (depicted in red, as was measured when two horns were facing each other). Overall, at the optimum 31.1 GHz frequency, reflectarray is worse than the mirror by about 9 dB, about 4 dB of which comes from a larger accumulated optical path. The remaining about 5 dB losses result in about 2.5 dB per sample which is comparable to the value obtained in FIG. 8C. Small extra losses may result from destructive interferences originating in a lattice mismatch of elements comprising stacked reflectarrays as well as by the non-flatness of our attached samples.

Finally, complementary measurements at higher distances were performed, with transmitter and receiver horns being located 7.62 m (25 feet) and 10.7 m (35 feet) away from reflectarrays (FIG. 10E). In this case, a different setup was used that consists of a signal generator on the TX side and an amplifier with voltmeter on the RX side. The resulting measurements at the optimum performance of 31.1 GHz are shown in blue for reflectarray and in green for a specular Al mirror. For Al mirror, the theoretical curve was plotted that corresponds to the (equivalent to the free-space) sum-distance path loss model, Pᵣ˜(d₁+d₂)⁻², where d₁(d₂) is the distance from transmitter (receiver) (Wu, 2021). Overall, it was observed that at higher distances, Example 6 is worse than Al mirror by about 17 dB. A twice larger value compared with the earlier about 9 dB figure is likely a consequence of poorer sample and horn alignment at higher distances.

From the results for Example 6, it was found that reflectarrays work quite well even after being combined together (even though their reflectarray angles are slightly out of spec). Although the resulting performance is somewhat worse than that of Al mirror, it is at least about 50 dB better compared to a case when nothing is present on the walls of L-junction. It can be expected that reflectarrays, once they are properly pre-modeled and arranged together, can substantially improve mm-wave signal propagation in problematic NLOS areas such as in hallway junctions.

What is claimed is:

1. A method of enhancing non-line-of-sight (NLOS) signal for wireless communications, the method comprising:
providing a plurality of passive reflectarrays including a first reflectarray and a second reflectarray, at least one of the reflectarrays comprising a pattern of repeating unit cells of resonating elements configured to reflect an incident radiofrequency (RF) electromagnetic wave at a wavelength λ in a range from about 1.0 mm to about 10.0 cm, the first reflectarray having a first phase gradient along a first longitudinal direction thereof, the second reflectarray having a second phase gradient along a second longitudinal direction thereof; and
positioning at least one of the first and second passive reflectarrays to face to the incident RF electromagnetic wave such that the incident RF electromagnetic wave is reflected by the first and second passive reflectarrays with a signal improvement of at least 3 dB.

2. The method of claim 1, wherein at least one of the first reflectarray and the second reflectarray delivers a non-linear steering performance.

3. The method of claim 1, wherein at least one of the first reflectarray and the second reflectarray delivers an angular-spatial separation.

4. The method of claim 1, wherein the at least one of the first reflectarray and the second reflectarray delivers a beam splitting performance.

5. The method of claim 1, wherein at least one of the plurality of passive reflectarrays is positioned on a ceiling or a floor at a T-, L-, or four-way junction.

6. The method of claim 5, wherein the at least one of the plurality of passive reflectarrays delivers an off-plane of incidence steering.

7. The method of claim 1, wherein the incident RF electromagnetic wave is from a network featuring adaptive beamforming on a transmitting or receiving end.

8. A system of enhancing non-line-of-sight (NLOS) signal for wireless communications, the system comprising:
one or more passive reflectarrays, at least one of the reflectarrays comprising a pattern of repeating unit cells of resonating elements configured to reflect an incident radiofrequency (RF) electromagnetic wave at a wavelength λ in a range from about 1.0 mm to about 10.0 cm,
wherein the one or more passive reflectarrays comprise at least one of a first reflectarray configured to split an incident beam and a second reflectarray configured to steer the incident beam with an off-plane of incidence.

9. The system of claim 8, wherein the resonating elements of the first reflectarray rows are arranged with alternating row directions.

10. The system of claim 8, wherein the resonating elements of the first reflectarray rows are arranged in a checkerboard pattern.
